(19) United States
(12) Patent Application Publication
(10) Pub. No.: US 2026/0225843 A1
(43) Pub. Date: Aug. 6, 2026

(54) Joining Device for Joining Label Tapes

(71) Applicant: Krones AG, Neutraubling (DE)

(72) Inventor: Tobias EHRISMANN, Burglengenfeld (DE)

(21) Appl. No.: 19/420,110

(22) Filed: Dec. 15, 2025

(30) Foreign Application Priority Data
Jan. 31, 2025 (DE) 102025103615.2

(51) Int. Cl. B65H 21/00

(52) U.S. Cl. CPC B65H 21/00; B65H 2701/192

(57) ABSTRACT

A joining device for joining label tapes includes two joining elements, each for guiding a production label tape and a connecting label tape. Each joining element includes a holding element for holding a label tape on a side facing the other joining element. The two joining elements are movably arranged so that they can be moved substantially rectilinearly relative to one other in one direction of movement and are offset from one another in a preparation position intended for joining the connecting label tape to the holding element such that the holding element is accessible.

### CROSS-REFERENCE TO RELATED APPLICATIONS

This application claims priority to, and the benefit of, German Patent Application No. 102025103615.2, filed January 31, 2025. The contents of that application are incorporated by reference herein in their entirety.

### TECHNICAL FIELD

The present invention relates to a joining device for joining label tapes, to a labeling machine for labeling containers, and to a method for joining label tapes using a joining device.

### PRIOR ART

Joining devices for joining label tapes are generally known from the prior art. These include, for example, movable rollers and similar elements for transporting label tapes, as well as elements for holding label tapes to be joined. The joining devices are used so that when a first roll of label tape (of the current production label tape) runs out, it is possible to join the end of this label tape roll to the beginning of a new label tape roll (of the connecting label tape). The label tape rolls are usually manually joined by an operator, for example, applying double-sided adhesive tape to the connecting label tape that is to be joined to the present production label tape and using the joining device to deliver this end of the label tape to the production label tape and join it via the double-sided adhesive tape. The production label tape is then cut upstream of the joining point in the conveying direction so that subsequently, when transport of the label tapes resumes, the connecting label tape continues to be conveyed.

Since joining is done manually, access must be created via which the operator can join the joining label tape to the joining element. At the same time, it must be ensured that the label tapes are not damaged when joining the connecting label tape to the present production label tape. This involves structural difficulties.

### BRIEF SUMMARY

Proceeding from the known prior art, the technical problem is therefore that of specifying a joining device for joining label tapes, with which an operator can easily join a production label tape and a connecting label tape while simultaneously avoiding damage to the label tapes.

According to the invention, a joining device for joining label tapes is provided, the joining device comprising two joining elements each for guiding a production label tape and a connecting label tape, wherein each joining element comprises a holding element for holding a label tape on a side facing the other joining element, and wherein the two joining elements are movably arranged so that they can be moved substantially rectilinearly relative to one another in one direction of movement and are offset from one another in a preparation position intended for joining the connecting label tape to the holding element such that the holding element is accessible.

For the purposes of the invention, production label tape is to be understood to mean the label tape that is currently being transferred to containers or to further devices arranged downstream of the joining device. The connecting label tape is to be understood as the label tape that is joined to the production label tape in order to subsequently serve as the production label tape. It goes without saying that the joining elements are each suitable and configured to transport both the production label tape and the connecting label tape, depending on which label tape is currently performing which task. For this purpose, the joining elements can receive the label tapes, for example from a label tape feed comprising a roll of label tape, for example. This can be arranged upstream of the joining elements in the conveying direction and can feed each label tape to a joining element.

Within the context of the invention, the preparation position is to be understood to mean a position of at least one joining element in which it is possible for an operator to join the connecting label tape to the holding element of the joining element or arrange it thereon. In this sense, the accessibility of the holding element according to the invention is thus to be understood as meaning that, in a region around the holding element, no other components, in particular no other joining elements, prevent an operator from attaching the connecting label tape to the holding element.

Substantially rectilinear movement is generally understood to mean movement in a straight line. In particular, straight movement or substantially straight movement is to be understood as movement which does not require, or rules out, mounting the joining elements on a rotational shaft. However, it may be provided within the context of the invention that the substantially straight movement has, for example, one or more curved portions in order to create a distance between the joining elements transversely to the conveying direction. This can be achieved, for example, by appropriately moving the joining elements along a curved guide.

Arranging the joining elements in such a way that at least one of the joining elements can be moved into a preparation position in which the holding element is accessible to an operator makes it possible for the operator to easily join the label tape to the holding element, while at the same time preventing the label tape from tearing when joining the connecting label tape to the production label tape.

The holding element may include a suction element and/or a clamping element for holding a label tape.

The suction element can, for example, comprise one or more suction cups or be configured as such, which can hold a label tape by applying a vacuum. The clamping element can, for example, be configured as a clamping jaw that can move relative to a fixed part of the joining element, or as two clamping jaws that can be advanced toward one another. These holding elements ensure that a label tape can be fastened easily and reliably by the operator.

In one embodiment, the joining elements are arranged on a guide such that they can move independently of one another.

The guide can be configured, for example, as a rail or as a pair of rails, and each joining element can be arranged on independent rails or guides. The guide can be configured in such a way that it completely defines the movement path of each joining element. This therefore means that the movement of the joining element into the preparation position is defined solely by the shape of the guide. The guide can be configured in particular as a linear guide or comprise one or more bent or curved portions. Providing such a guide provides a reliable and simultaneously easy-to-use way of moving the joining elements into the preparation position.

The guide can be configured so that the joining elements can be fixed in the preparation position and/or the production position. For fixing them, for example a clamp or bolt or the like can be provided which can be joined to the joining element in the preparation position so that the joining element can no longer be moved along the guide. This ensures that the joining element is securely positioned in the preparation position.

It may be provided that the joining elements are manually movable on the guide or that the joining device comprises a drive element for moving the joining elements along the guide.

As a result of the movement of the joining elements along the guide being a manual movement, the complexity of the joining device is reduced. A servo drive or a pneumatic drive, for example, can be provided as the drive element. This can simplify usability.

In one embodiment, it is provided that the joining elements can be moved into a joining position in which the holding elements substantially coincide in the direction of movement.

The holding elements hold the production label tape and the connecting label tape in the joining position. In this position, the label tapes can then be joined, for example by joining them using double-sided adhesive tape. Optionally, the production label tape can then be cut upstream of the point where the production label tape is joined to the connecting label tape (for example, upstream of the holding elements) so as to subsequently be able to move forward with transporting the label binders, with the connecting label tape then serving as the production label tape. This allows for a reliable joining between the production label tape and the connecting label tape.

It may be provided that the joining elements can be moved into a production position that is spaced apart from the preparation position in the direction of movement.

The production position can in particular be arranged downstream of the preparation position in the conveying direction or direction of movement. This embodiment can further improve access to the holding element. This avoids or reduces the risk of damage to the label tapes when moving from the preparation position to the production position.

The joining position can correspond to the preparation position or the production position.

It may be provided that, in the preparation position, the holding element of one joining element is spaced apart from the other joining element in the direction of movement and optionally transversely to the direction of movement. Accordingly, in the preparation position, the holding element projects beyond the other joining element in the direction of movement, making it easily accessible to an operator. If the holding element is optionally also provided at a distance transversely to the conveying direction, access can be further improved. Any desired distance can in principle be chosen, but can at least be a few centimeters, such as at least 5 cm or at least 10 cm, so that the operator can easily join the connecting label tape to the holding element.

According to the invention, a labeling machine for labeling containers is further provided, the labeling machine comprising two label tape feeds for providing label tapes and a conveying device for conveying the label tapes in a conveying direction, wherein the labeling machine comprises, downstream of the label tape feeds and upstream of a point where labels are transferred to containers, a joining device for joining the label tape of one label tape feed to the label tape of the other label tape feed.

This labeling machine allows for easy and simultaneously reliable joining of label tapes by an operator.

Furthermore, according to the invention, a method for joining label tapes using a joining device is provided, the joining device comprising two joining elements, each for guiding a production label tape and a connecting label tape, wherein each joining element comprises a holding element for holding a label tape on a side facing the other joining element, and wherein the two joining elements are movably arranged so that they can be moved substantially rectilinearly in one direction of movement and, when in a preparation position intended for joining the connecting label tape to the holding element, are offset from one another in the direction of movement so that the holding element is accessible. The method comprises moving a joining element into the preparation position, subsequently fastening the connecting label tape to the holding element, and subsequently joining the connecting label tape to the production label tape.

This method ensures simple and at the same time reliable joining of label tapes.

The method may further comprise moving the joining elements into a joining position in which the holding elements substantially coincide in the direction of movement after fastening the connecting label tape and before joining the connecting label tape. This embodiment can ensure that the label tapes are reliably joined.

In one embodiment, after joining the connecting label tape, the method further comprises moving the joining elements into a production position that is at a distance from the preparation position in the direction of movement.

Providing a production position that is at a distance from the preparation position in the conveying direction or the direction of movement may in particular further comprise arranging the joining elements in the production position downstream of the preparation position. This can further improve access to the holding element.

The joining position can correspond to the preparation position or the production position. This reduces the complexity of joining the label tapes.

The joining device can be a joining device according to any one of the preceding embodiments.

The advantages described in connection with the joining device are thereby realized when joining label tapes.

### BRIEF DESCRIPTION OF THE FIGURES

FIG. 1 is a schematic illustration of an embodiment of a labeling machine.

FIGS. 2 to 4 are schematic illustrations of different arrangements of the joining elements in different positions according to one embodiment.

### DETAILED DESCRIPTION

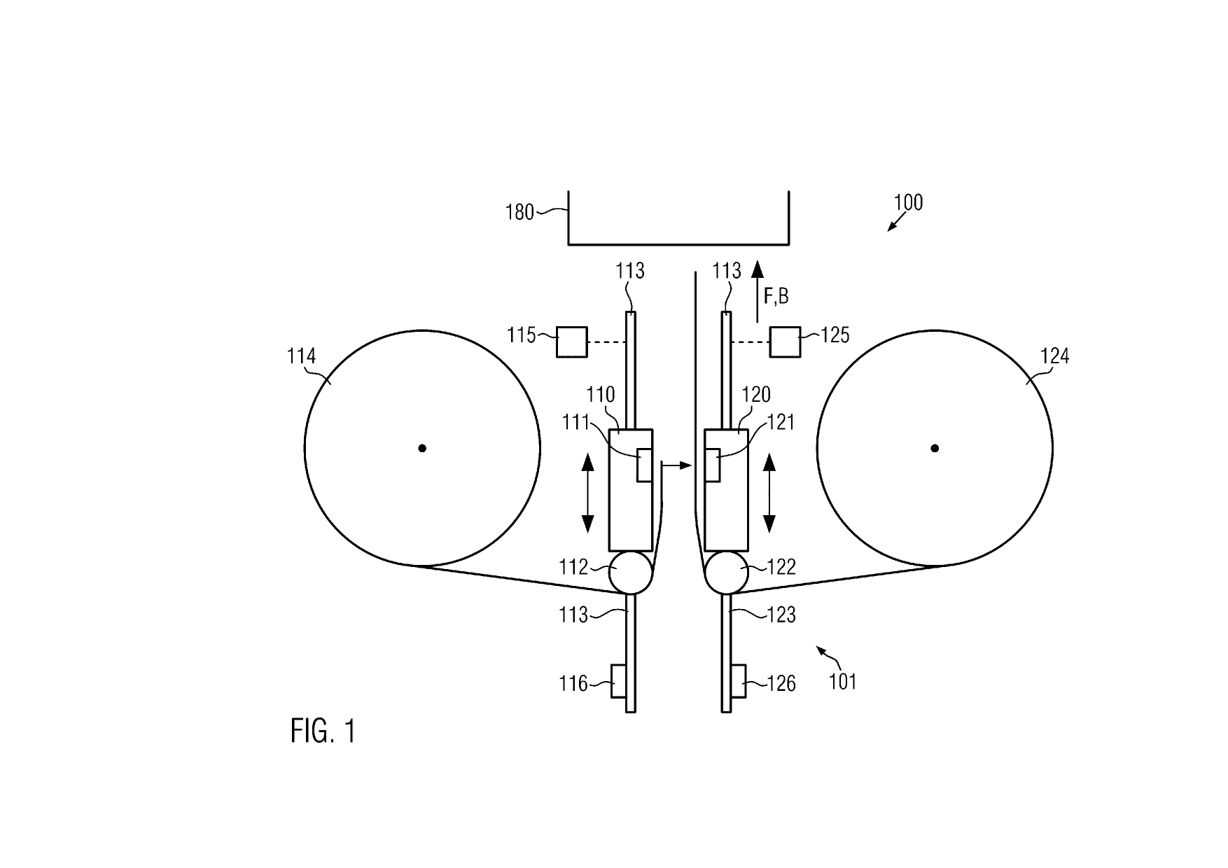

FIG. 1 is a schematic illustration of a labeling machine 100 according to one embodiment. The labeling machine 100 can comprise a structure that is customary per se and that can comprise a plurality of components 180 (not specified in more detail here) in a label tape conveying direction F. These devices include, for example, a cutting apparatus that can separate labels from a label strip and one or more transport devices that can in particular convey the separated labels.

The labeling machine may comprise additional transport devices (for example a carousel with receptacles for containers) in which containers, such as bottles, cans, tubes or the like, can be transported and to which the labels can be transferred.

In the embodiment shown here, the labeling machine 100 comprises two label tape feeds 114 and 124 upstream in the label tape conveying direction F. The label tape feeds can be, for example, label tape rolls that are rotatably arranged on a receptacle so that they can be unwound in a conveying direction F. Each label tape roll in the label tape feed has a finite length and therefore a finite number of labels. During operation of the labeling machine 100, it is therefore necessary to switch out one label tape roll for another label tape roll at certain intervals. For example, the label tape roll in the label tape receptacle 124 can be understood to mean a production label tape, from which labels are conveyed in the conveying direction F during the operation of the labeling machine 100 and fed to the other components 180 of the labeling machine. The label tape roll or label tape in the label tape feed 114 can be understood to mean a connecting label tape, which is to be used as a (new) production label tape when the end of the production label tape is approaching. In order to make it possible to change from supplying label tape from the label tape feed 124 to the label tape feed 114, it is generally known from the prior art to join the production label tape to the connecting label tape at a specific point. For this purpose, for example, the beginning of the connecting label tape can be provided with double-sided adhesive tape or another adhesive and joined to part of the production label tape.

According to the invention, a joining device 101 is provided to join the label bands in this way. According to the invention, the joining device comprises two joining elements 110 and 120, each comprising a holding element 111 and 121, respectively, for holding a label tape. The holding elements can, for example, each comprise one or more suction cups or suction elements joined to a vacuum pump or similar element to selectively create a negative pressure. This negative pressure can be used to hold a label tape in the region of the holding element.

Alternatively or additionally, the holding element of each joining element can also comprise one or more clamping elements, such as pre-tensioned gripping fingers, which are pre-tensioned against the surface of the joining element and between which a label tape can be manually clamped, for example by pulling the holding fingers away from the surface of the joining element, pushing the label tape therebetween and tensioning the fingers again toward the joining element. However, these embodiments are not mandatory and any other configuration of a holding element is also conceivable.

Each joining element can comprise one or more deflection elements 112 and 122 upstream of the holding elements 111 and 121, respectively, in the conveying direction F, which can be configured, for example, as rollers and can be provided for deflecting each label tape from the label tape feed 114 and 124 in the direction of the holding element 111 and 121, respectively.

According to the invention, the joining elements are arranged to be rectilinearly movable substantially in parallel with one another in a direction of movement B so that they can be moved into different positions. It can be provided in only one embodiment and without loss of generality that the direction of movement B coincides with, for example, the conveying direction F of the label tapes downstream of the joining device 101 or runs in parallel therewith. The movable arrangement of the joining elements 110 and 120 is configured such that one of the joining elements can preferably be moved independently of the other joining element and, in particular according to the invention, can be moved such that in a preparation position, in which the label tape can be arranged on the holding element for subsequently joining the label tapes, it is offset from the other joining element such that the holding element of the joining element is accessible to an operator for joining the connecting label tape to the holding element. This means that, in this position referred to as the preparation position, the joining element to which, or to the holding element of which, the new label tape (for example, the label tape of the label tape feed 114) is to be joined, can be offset from the other joining element 120. The offset in direction B is chosen such that the holding element 111 is accessible to the operator.

The movable arrangement of the joining elements 110 and 120 can, for example, include the fact that they are arranged on guides 113 and 123, preferably separate ones, such as rails, along which they can be moved in direction B. The direction of movement B can be, in particular, straight or substantially straight and may, for example, also include one or more at least partially curved portions. However, according to the invention, the movable arrangement of the joining elements is at least an arrangement that does not comprise mounting the joining elements such that they can rotate about an axis of rotation.

The guides 113 and 123, for example, can be provided to have a curvature so that a joining element moved into the preparation position is not only spaced apart from the other joining element in the direction of movement B, but is also at a greater distance from the other joining element in a direction that is transverse to the direction of movement than is the case in the joining positions and production positions yet to be described.

The movement of the joining elements along the guides 113 and 123 can be performed manually, for example by the operator releasing a locking element (not shown here) of each joining element, moving the joining element into the desired position and then fastening the joining element once again, for example. This prevents the joining elements from moving unintentionally. Alternatively, it can also be provided that each joining element is assigned a drive element 115 and 125, which can cause each joining element to move along the guides. The drive element 115 and 125 can be, for example, a motor, in particular a servo drive, an actuator or any other electric motor. Alternatively, the drive element can also be configured as a pneumatic element. While it may generally be advantageous to provide separate drive elements for each joining element, it is also possible to provide only one common drive element which can cause only one of the joining elements to move, for example to move it into the preparation position, for example through appropriate control commands and/or suitable mechanical joining means.

While it may generally be provided that the joining element to which a label tape is to be joined in the preparation position is moved into this preparation position, according to the invention it may also be provided that this joining element instead remains in its position and only the other joining element is moved into a position in which the holding element of the first-mentioned joining element, to which the connecting label tape is joined, is accessible. In this respect, only the relative mobility of the joining elements is relevant, which is chosen such that, in a preparation position, a joining element to be joined to the connecting label tape is accessible, in particular the holding element of this joining element is accessible.

In the embodiment shown in FIG. 1, however, the preparation position is provided such that the joining element, which is to be joined to the connecting label tape, is moved into the corresponding preparation position along the guide 113. It may be provided that each joining element can be fixed in the preparation position by a suitable fixing element. The fixing elements 114 and 124 could, for example, be clamps or the like. If, in order to reach the preparation position, it is not the joining element intended to be joined to the connecting label tape that is moved but the other joining element, the fixing element (here, for example, the fixing element 124) of the other joining element can be offset in the direction of movement B along the guide 113 in the direction of the arrow shown.

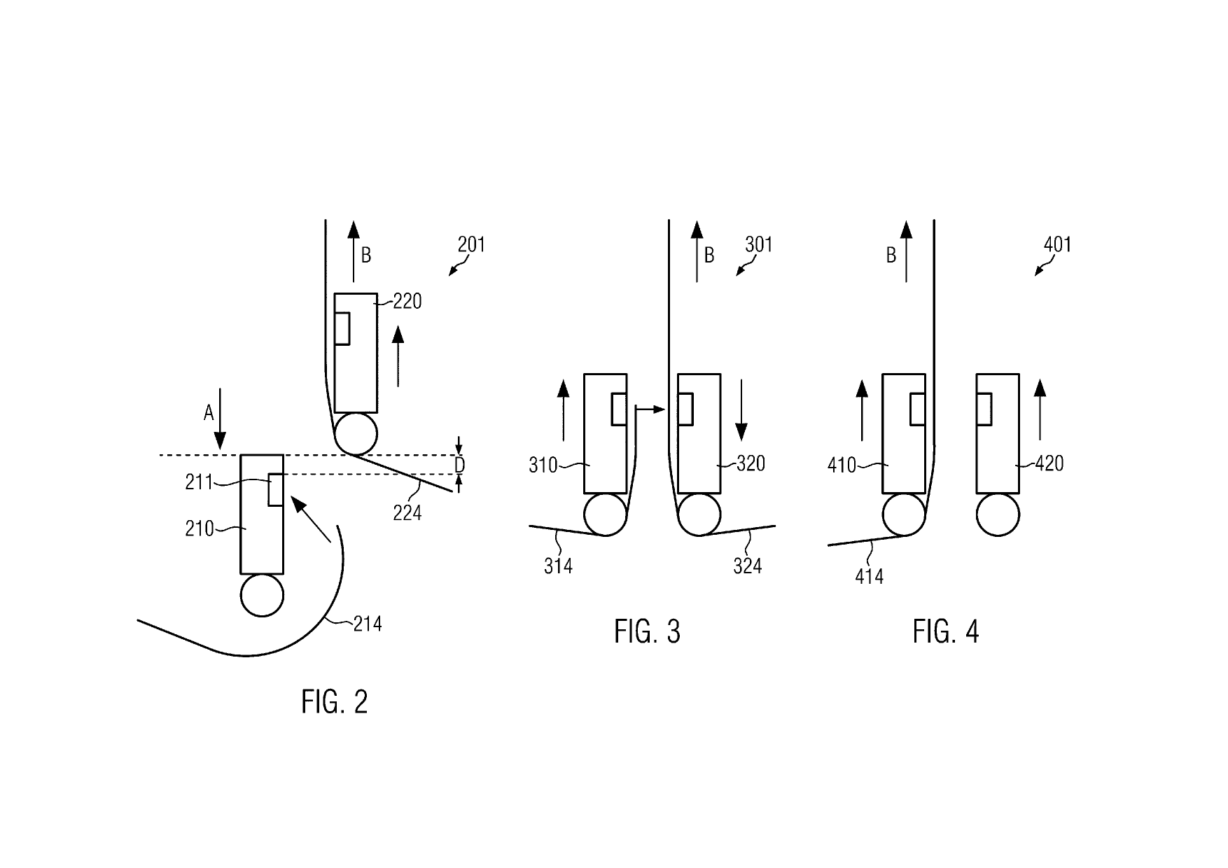

Although not shown here, it may be provided that corresponding fixing elements are also provided for other positions to be assumed by the joining elements, such as a joining position and a production position, as described below in connection with FIGS. 2 to 4. Each of the fixing elements can be configured analogously to the described fixing elements 114 and 124 and enable each of the joining elements to be fixed in the corresponding position as independently as possible of any movement of the other joining element.

FIGS. 2 to 4 show the positions and movement of the joining elements during different phases of the method of joining label tapes. The embodiments in FIGS. 2 to 4 can be combined with all the embodiments described in connection with FIG. 1.

For illustrative purposes only, it is provided here that to join the connecting label tape to the corresponding joining element, said joining element is moved into the preparation position. However, as already described with reference to FIG. 1, it can also be provided that instead of the joining element to which the connecting label tape is to be joined, it is the other joining element that is moved into a position such that the holding element of the joining element to which the connecting label tape is to be joined is accessible.

In FIG. 2, the joining device 201 is shown such that the joining element 210 is moved into the preparation position. As can be seen, the joining element 210 is spaced apart in the direction of movement B from the joining element 220, around which the production label tape runs, by the distance A. This distance is measured in this case from the rear side of the joining element 220 to the rear side of the joining element 210, but can also be measured in any other way.

Preferably, at least the holding element 211 has a distance D from the joining element 220 in the direction of movement B. In the preparation position shown here, the joining element 210 can, for example, be spaced apart from the joining element 220 such that at least the holding element 211 has a distance D, i.e. the shortest distance from part of the joining element 220 in the direction of movement B, but parts of the joining element 210 overlap with the other joining element in the direction of B. This distance D can ensure access to the holding element so that the connecting label tape 214 can be joined to and held by the holding element 211 of the joining element 210. The distance D can in principle be of any size, but can, for example, be several centimeters, such as up to or at least 5 cm or up to or at least 10 cm, to ensure that an operator can even join the connecting label tape 214 to the holding element 211 past the production label tape 224.

FIG. 3 shows a view of the joining device 301 in which the joining elements 310 and 320 have been moved into a joining position. In the embodiment shown here, it is provided that, for this purpose, the joining element 220 of FIG. 2 is moved in the direction of the joining element 310 in the direction of movement B (or counter thereto) and, without loss of generality, is moved into the same position in direction B in which the joining element 310 is also arranged. If the joining element was not moved out of its preparation position, the joining position of the joining elements 310 and 320 coincides with the preparation position of the joining element 210 according to FIG. 2. In the joining position, the holding elements of the joining elements can preferably coincide in direction B, i.e., are not spaced apart from one another in direction B.

Alternatively, however, it may also be provided that the joining position, in which the connecting label tape 314 is joined to the production label tape 324, differs from the preparation position. For example, it may be provided that instead of the joining element 320, the joining element 310 is moved from the preparation position 210 to the joining position. For example, the joining position may also coincide with a production position, for example in which the joining element 220 in FIG. 2 may have remained, or the joining position may be arranged between the preparation position and the production position in the direction of movement B. In the joining position, the connecting label tape and the production label tape are now joined together by, for example, bringing the end of the connecting label tape, which may be equipped with an adhesive, such as double-sided adhesive tape, into contact with the production label tape in the region of the holding elements.

Subsequently, in the joining position, the present production label tape can be cut upstream of the holding elements in the conveying direction of the label tapes. This terminates the present production label tape, and the resulting label tape at least partially consists of the end of the production label tape and the joined end of the connecting label tape.

In the embodiment shown in FIG. 4, the joining elements 410 and 420 (or at least the joining element that conveys the new production label tape) can now be moved from the joining position to their production position, in which transport of the production label tape (now the label tape 414) is then continued. The joining element 410 then conveys this production label tape in the conveying direction, whereas the joining element 420 initially performs no further functions. The label roll or label tape assigned to the joining element 420 can then be replaced in order to be available when subsequently changing the label tapes. During the subsequent changing process, the production label tape is the label tape 414, and a new connecting label tape is provided on the side shown here on the right or by the joining element 420 and can be joined to the production label tape 414 according to the embodiments described thus far.

I claim:

1. A joining device for joining label tapes, the joining device comprising:
two joining elements, each for guiding a production label tape and a connecting label tape, wherein each joining element comprises a holding element for holding a label tape on a side facing the other joining element, and wherein the two joining elements are movably arranged so that they can be moved substantially rectilinearly relative to one other in one direction of movement and are offset from one another in a preparation position intended for joining the connecting label tape to the holding element such that the holding element is accessible.

2. The joining device according to claim 1, wherein the holding element comprises a suction element and/or a clamping element for holding a label tape.

3. The joining device according to claim 1, wherein the joining elements are arranged on a guide such that they can move independently of one another.

4. The joining device according to claim 3, wherein the guide is configured such that the joining elements can be fixed in the preparation position and/or the production position.

5. The joining device according to claim 3, wherein the joining elements are manually movable on the guide or wherein the joining device comprises a drive element for moving the joining elements along the guide.

6. The joining device according to claim 1, wherein the joining elements are movable into a joining position in which the holding elements substantially coincide in the direction of movement.

7. The joining device according to claim 6, wherein the joining elements are movable into a production position which is at a distance from the preparation position in the direction of movement.

8. The joining device according to claim 7, wherein the joining position corresponds to the preparation position or the production position.

9. The joining device according to claim 1, wherein, in the preparation position, the holding element of one joining element is spaced apart from the other joining element in the direction of movement and optionally transversely to the direction of movement.

10. A labeling machine for labeling containers, the labeling machine comprising:
two label tape feeds for providing label tapes and a conveying device for conveying the label tapes in a conveying direction, wherein the labeling machine comprises, downstream of the label tape feeds and upstream of a point where labels are transferred to containers, a joining device according to claim 1 for joining the label tape of one label tape feed to the label tape of the other label tape feed.

11. A method for joining label tapes using a joining device, the joining device including two joining elements, each for guiding a production label tape and a connecting label tape, wherein each joining element comprises a holding element for holding a label tape on a side facing the other joining element, and wherein the two joining elements are movably arranged so that they can be moved substantially rectilinearly in one direction of movement and are offset from one another in the direction of movement when in a preparation position for joining the connecting label tape to the holding element such that the holding element is accessible, the method comprising:
moving a joining element into the preparation position,
subsequently fastening the connecting label tape to the holding element, and
subsequently joining the connecting label tape to the production label tape.

12. The method according to claim 11, wherein the method further comprises moving the joining elements into a joining position, in which the holding elements substantially coincide in the direction of movement, after fastening said connecting label tape and before joining said connecting label tape.

13. The method according to claim 12, wherein, after joining said connecting label tape, the method further comprises moving the joining elements into a production position which is spaced apart from the preparation position in the direction of movement.

14. The method according to claim 13, wherein the joining position corresponds to the preparation position or the production position.

15. The method according to claim 11, wherein the holding element comprises a suction element and/or a clamping element for holding a label tape.

16. The method according to claim 11, wherein the joining elements are arranged on a guide such that they can move independently of one another.

17. The method according to claim 16, wherein the guide is configured such that the joining elements can be fixed in the preparation position and/or the production position.

18. The method according to claim 16, wherein the joining elements are manually movable on the guide or wherein the joining device comprises a drive element for moving the joining elements along the guide.

19. The method according to claim 11, wherein the joining elements are movable into a joining position in which the holding elements substantially coincide in the direction of movement.

20. The method according to claim 19, wherein the joining elements are movable into a production position which is at a distance from the preparation position in the direction of movement.

21. The method according to claim 20, wherein the joining position corresponds to the preparation position or the production position.

22. The method according to claim 11, wherein, in the preparation position, the holding element of one joining element is spaced apart from the other joining element in the direction of movement and optionally transversely to the direction of movement.
